(19) United States
(12) Patent Application Publication
(10) Pub. No.: US 2006/0145370 A1
(43) Pub. Date: Jul. 6, 2006

(54) Optical tool assembly

(76) Inventors: Bruce E. Lawton, Rochester, NY (US); Thomas G. Jones, Rochester, NY (US); Scott L. Milliken, Rochester, NY (US)

Correspondence Address: Bausch & Lomb Incorporated, One Bausch & Lomb Place, Rochester, NY, 14604-2701, US

(21) Appl. No.: 11/027,380

(22) Filed: Dec. 30, 2004

(51) Int. Cl. B29D 11/00

(52) U.S. Cl. 264/1.32; 264/2.5; 425/808

(57) ABSTRACT

An apparatus and method is provided for injection molding an ophthalmic lens mold having an optical surface and a non-optical surface opposite the optical surface. The apparatus includes a non-optical tool assembly for forming the non-optical surface of the ophthalmic lens mold and an optical tool assembly in opposed relation to the non-optical tool assembly that together therewith forms a mold cavity for forming the ophthalmic lens mold. The assembly includes a cavity ring removably secured to a mold plate of an injection molding apparatus and an optical tool insert having an optical molding surface thereon for forming the optical surface of the ophthalmic lens mold. The optical tool insert is removably secured to the cavity ring.

### RELATED APPLICATION

This application is related to the U.S. patent applications entitled, respectively, “OPTICAL TOOL ASSEMBLY FOR IMPROVED RCW AND LENS EDGE FORMATION” (Attorney Docket No. P03453), “NON-OPTICAL MULTI-PIECE CORE ASSEMBLY FOR RAPID TOOL CHANGE” (Attorney Docket No. P03454) and “CORE LOCKING ASSEMBLY AND METHOD FOR ORIENTATION OF ASYMMETRICAL TOOLING” (Attorney Docket No. P03455); all filed concurrently herewith, commonly assigned to Bausch & Lomb Incorporated and expressly incorporated herein by reference.

### BACKGROUND

The present disclosure relates to the molding of articles of manufacture. More particularly, the disclosure relates to an improved optical tool assembly for injection molding preforms used in the manufacture of ophthalmic lenses, such as contact lenses and intraocular lenses, and will be described with particular reference thereto. It is to be appreciated, however, that the improved optical tool assembly and apparatus related thereto is adapted to effective use in other environments and applications.

One method in practice for making ophthalmic lenses, including contact lenses and intraocular lenses, is cast molding. Cast molding of ophthalmic lenses involves depositing a curable mixture of polymerizable lens materials, such as monomers, in a mold cavity formed by two assembled mold sections, curing the mixture, disassembling the mold sections and removing the molded lens. Other post-molding processing steps, for example, hydration in the case of hydrogel lenses, may also be employed. Representative cast molding methods are disclosed in U.S. Pat. No. 5,271,875 (Appleton et al.); U.S. Pat. No. 4,197,266 (Clark et al.); U.S. Pat. No. 4,208,364 (Shepherd); U.S. Pat. No. 4,865,779 (Ihn et al.); U.S. Pat. No. 4,955,580 (Seden et al.); U.S. Pat. No. 5,466,147 (Appleton et al.); and U.S. Pat. No. 5,143,660 (Hamilton et al.).

When cast molding between a pair of mold sections, typically one mold section, referred to as the anterior mold section or preform, forms the anterior convex, optical surface of the ophthalmic lens and the other mold section, referred to as the posterior mold section or preform, forms the posterior concave, optical surface of the ophthalmic lens. The anterior and posterior mold sections are generally complimentary in configuration. They are joined together during the molding process to form a lens forming or molding cavity. Once the lens is formed, the mold sections are separated and the molded lens is removed. The anterior and posterior mold sections are usually used only once for casting a lens prior to being discarded due to the significant degradation of the optical surfaces of the mold sections that often occurs during a single casting operation.

Formation of the mold sections used in casting occurs through a separate molding process prior to cast molding of the lens. In this regard, the mold sections are first formed by injection molding a resin in the cavity of an injection molding apparatus. More particularly, mounted in the injection molding apparatus are tools for forming the mold sections. Typically, the tools are fitted into mold plates in the injection molding machine and the mold sections are produced by injection molding a selected resin between opposed sets of injection molding tools. The tools are typically made, e.g., from brass, stainless steel, nickel, or some combination thereof and, unlike the mold sections which are used only once, are used again and again to make large quantities of mold sections.

The injection molding tools are typically formed in accordance with the specification of corresponding ophthalmic lens surfaces to be formed on or by the mold sections. That is, the ophthalmic lens being produced determines the specific design of the mold sections. The needed mold section parameters, in turn, determine the design of the corresponding injection molding tools. The injection molding tools are typically manufactured to extremely high specifications and/or tolerances so that no roughness or surface defects are transferred to the mold sections being made from the tools. Any such defects on the mold sections, particularly on an optical surface of a mold section, is likely to be transferred to, and appear on, the finished lens during the cast molding operation.

Each mold section, whether it be a posterior mold section or an anterior mold section, includes an optical surface (posterior optical surface on a posterior mold section and anterior optical surface on an anterior mold section) that forms a surface of the ophthalmic lens, as well as a non-optical surface. When injection molding the mold section, the injection molding apparatus typically includes an optical tool assembly having an optical molding surface for forming the optical surface of the mold section and a non-optical tool assembly for forming the non-optical surface of the mold section, which is opposite the optical surface. As is known to those skilled in the art, the optical molding surface can be changed for purposes of producing mold sections of different thicknesses, which in turn are used to produce ophthalmic lenses of varying powers.

Various improvements have been made to the optical tooling assembly to enable more rapid removal and replacement of the optical molding surface. For example, some optical tool assemblies include a removable optical tool insert having the optical molding surface thereon. Due to its removability, the optical tool insert can be readily changed without changing the entire optical tool assembly for purposes of producing ophthalmic lenses of varying powers. Such rapid changeability enables the molding of a wider range of mold sections that can then be used to produce lenses having varying powers (i.e., varying diopters) without requiring significant downtime of the injection molding apparatus for tooling changes. Despite this and other past improvements, any additional improvements that would enable even more rapid changes of the optical molding surface are considered desirable, particularly those that further reduce injection molding machine downtime associated with changes of the optical molding surface.

### BRIEF SUMMARY

According to one aspect, an optical tool assembly is provided for use in an injection molding apparatus opposite a non-optical tool assembly to form an ophthalmic mold section. More particularly, in accordance with this aspect, the optical tool assembly includes a water jacket mounted to an associated mold plate of the injection molding apparatus. A cavity ring is secured by a rotatable lock to the associated mold plate in abutting relation to the water jacket along a tapered interface. An optical insert is removably secured to the cavity ring and has an optical molding surface thereon for forming an optical surface of the ophthalmic mold section. The rotatable lock enables removal of the cavity ring when the cavity ring is rotated to an unlocked position.

According to another aspect, an apparatus and method is provided for injection molding an ophthalmic lens mold having an optical surface and a non-optical surface opposite the optical surface. More particularly, in accordance with this aspect, the apparatus includes a non-optical tool assembly for forming the non-optical surface of the ophthalmic lens mold and an optical tool assembly in opposed relation to the non-optical tool assembly that together therewith forms a mold cavity for forming the ophthalmic lens mold. The optical tool assembly includes a cavity ring and an optical tool insert. The cavity ring is removably secured to a mold plate of an injection molding apparatus. Axial removal of the cavity ring is enabled when the cavity ring is rotated to an unlocked position and prevented when the cavity ring is rotated to a locked position. The optical tool insert has an optical molding surface thereon for forming the optical surface of the ophthalmic lens mold and is removably secured to the cavity ring.

According to still another aspect, an injection molding apparatus is provided for forming a mold section which is subsequently used for forming an ophthalmic lens. More particularly, in accordance with this aspect, the injection molding apparatus includes a cavity ring having a tapered central protuberance. The cavity ring is mounted to a first mold plate. An optical tool insert having a molding surface with an optical quality finish is removably mounted to the cavity ring. A water jacket having a tapered recess is also mounted to the first mold plate with the tapered central protuberance of the cavity ring being received in the tapered recess of the water jacket and forming a tapered interface therewith. A core member is mounted to an associated second mold plate opposite the first mold plate. A non-optical tool insert having a first molding surface for forming a surface of the mold section opposite the optical surface is removably mounted to the core member.

According to still yet another aspect, a method for forming an ophthalmic lens is provided. More particularly, in accordance with this aspect, an injection molding apparatus having an optical tool assembly is provided. The optical tool assembly has an optical mold surface for forming an optical surface of an anterior mold section and a non-optical tool assembly in opposed relation to the optical tool assembly. The optical tool assembly and the non-optical tool assembly together form a mold cavity. The optical tool assembly includes a water jacket mounted to an associated mold plate of the injection molding apparatus. A cavity ring is mounted by at least one fastener to the associated mold plate in abutting relation to the water jacket along a tapered interface and an optical insert is removable secured to the cavity ring and has the optical mold surface thereon. The anterior mold section is injection molded in the mold cavity. The anterior mold section is removed from the mold cavity. The anterior mold section is matched with a posterior mold section. An ophthalmic lens is cast molded between the anterior mold section and the posterior mold section.

### BRIEF DESCRIPTION OF THE DRAWINGS

FIG. 1 is a schematic exploded view of a representative mold section assembly.

FIG. 2 is a schematic cross-sectional view of an injection molding arrangement having tooling assemblies (including an optical tool assembly and a non-optical tool assembly) for injection molding an anterior mold section of the mold assembly shown in FIG. 1.

FIG. 2A is an enlarged partial schematic cross-sectional view of the injection molding arrangement of FIG. 2.

FIG. 3 is a plan view of a cavity ring of the optical tool assembly of FIG. 2.

FIG. 4 is a perspective view of the cavity ring of FIG. 3.

FIG. 5 is a perspective view of a tool for facilitating removal of the cavity ring of FIG. 2.

FIG. 6 is a perspective view of a tool for facilitating removal of a body with an optical tool insert secured thereto from the cavity ring.

### DETAILED DESCRIPTION

Referring now to the drawings wherein the showings are for purposes of illustrating one or more embodiments and not for purposes of limiting the same, a representative mold assembly is shown in FIG. 1 and generally designated by reference numeral 10. The mold assembly 10 includes an anterior mold preform or section 12 and a posterior mold preform or section 14. When mold sections 12 and 14 are assembled, optical surfaces (only anterior molding surface 16 shown) of the mold sections 12,14 define a mold cavity in which an ophthalmic lens 18 is formed, such as by cast molding. The ophthalmic lens 18 can be, for example, a contact lens or intraocular lens. The optical surface of the mold section 14, also referred to herein as a posterior molding surface, is formed opposite non-optical surface 20. In the illustrated mold assembly 10, mold sections 12 and 14 additionally include respective cylindrical walls 22,24, respectively, and segment walls 26,28 that nest (but not necessarily touch or contact one another) when the mold sections are fully assembled.

As will be described in more detail below, each of the mold sections 12,14, also referred to herein as ophthalmic lens molds, can be injection molded from a plastic resin, such as polypropylene, polyvinyl chloride (PVC) or polystyrene, for example, in a full injection molding apparatus (not shown). As will be understood by those skilled in the art, the injection molded sections 12,14 can then be used in a cast molding process wherein a curable lens material, such as a liquid polymerizable monomer mixture, is introduced onto anterior molding surface 16, mold sections 12,14 are brought into close association with the liquid being compressed to fill the mold cavity formed between the sections 12,14, and the monomer mixture is cured into an ophthalmic lens, such as contact lens 18 shown in the illustrated embodiment. It should be readily appreciated by those skilled in the art that modified mold sections having different geometries could be formed and applied in the above-described cast molding process to produce any types of lenses (e.g., spherical, toric, multifocal, intraocular, etc.).

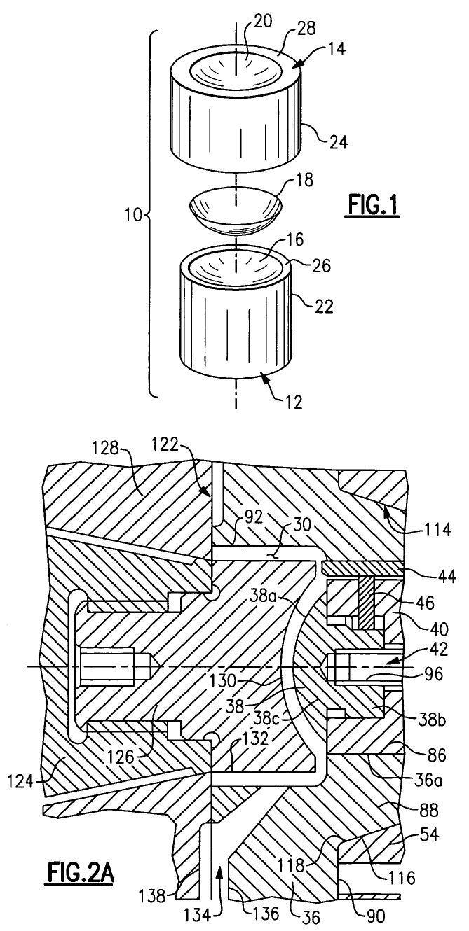

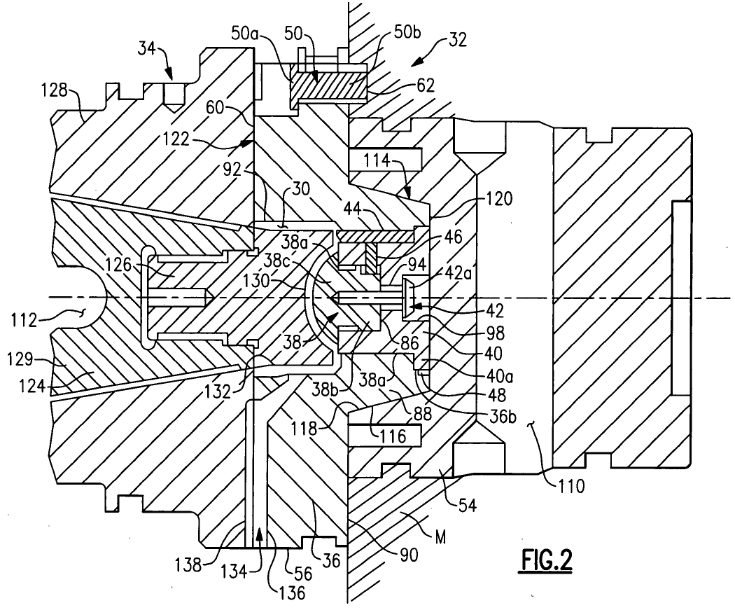

As will be understood by those skilled in the art, tool assemblies are mounted in the injection molding apparatus for forming the mold sections 12,14 by injection molding. The tool assemblies are mounted to and/or fitted into mold plates (only one shown as described below) of the injection molding apparatus and the mold sections 12,14 are formed by injection molding a selected resin in a cavity formed between opposed sets of tool assemblies. With additional reference to FIG. 2, only tool assemblies for forming the anterior mold section 12 will be described in further detail herein. However, as will be appreciated by those skilled in the art, the embodiment or embodiments discussed herein are easily adaptable for formation of the posterior mold section and both are considered within the scope of the invention both individually and collectively.

In FIG. 2, mold cavity 30 is formed between opposed tool assemblies, including optical tool assembly 32 and non-optical tool assembly 34, in which the mold section 12 of FIG. 1 can be formed. As illustrated, the optical tool assembly 32 forms the optical surface 16 of the mold section 12 and the non-optical tool assembly 34 forms the non-optical surface (not shown) on an opposite side of the surface 16. The tool assemblies 32,34 also combine to form the cylindrical wall 22 and the segment wall 26 of mold section 12.

The optical tool assembly 32 includes a cavity ring 36 and an optical tool insert 38 mounted to the cavity ring. More particularly, the optical tool insert 38 is removably secured to a body or body member 40 which is itself removably secured to the cavity ring 36. A suitable fastener, such as a threaded member or cap screw 42, removably secures the insert 38 to the body 40. The body 40, with the insert 38 secured thereto, is slidably received in cavity ring opening 36a and a shoulder 40a of the body is received in a counterbore 36b surrounding the opening 36a (FIG. 2). The shoulder 40a limits axial insertion of the body 40 into the cavity ring 36. Optionally, O-ring seal 48 is positioned radially between the body 40 and the cavity ring 36 to prevent accidental separation of these parts during manual handling thereof. Molding dowel 44 extends axially along the cavity ring 36 and body 40 and serves to lock the body 40 to the cavity ring 36. In addition, the dowel 44 extends into the cavity 30 to mark mold section 12 formed therein. Specifically, the dowel 44 marks the rotational orientation of the mold section 12 relative to the tool assembly 32. Clocking dowel 46 rotatably positions the insert 38 relative to the body 40.

The optical tool insert 38 includes optical molding surface 38a which has an optical quality finish to form the anterior molding optical surface 16 of mold section 12. As used herein, the term “optical quality finish” denotes a molding surface that is sufficiently smooth for forming optical surface 16 which ultimately forms the optical surface of a ophthalmic lens 18, i.e., the produced lens is suitable for placement in the eye without the need to machine or polish the formed lens surface. As will be appreciated by those skilled in the art, the insert 38 can be one of a set or series of inserts (not shown) and the removeability of the insert 38 enables it to be readily changed with another insert from the set of inserts. Each of the inserts in the set can have a different optical molding surface for purposes of ultimately molding lenses having differing optical powers.

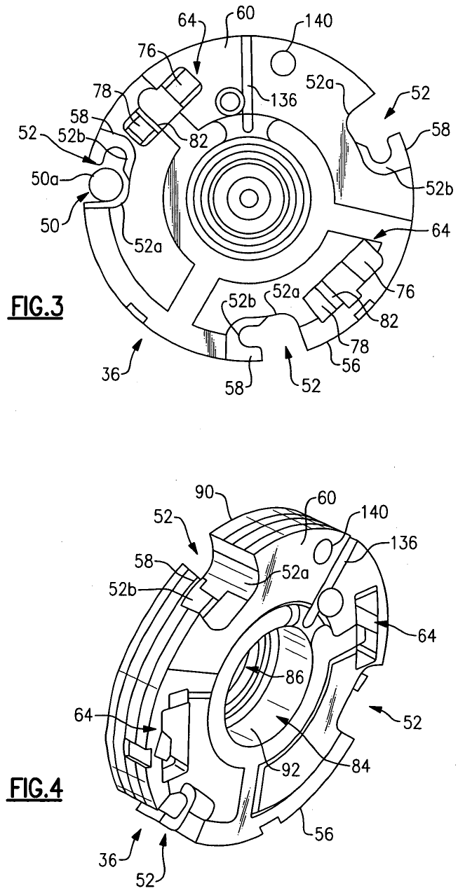

The cavity ring 36 is removably secured to mold plate M of the injection molding apparatus by a rotatable lock that enables axial removal of the cavity ring 36 from the mold plate M when the cavity ring is rotated to an unlocked position. More particularly, axial removal of the cavity ring 36 is enabled when the cavity ring is rotated to the unlocked position and prevented when the cavity ring is rotated to a locked position. In the illustrated embodiment, the rotatable lock includes fasteners, such as threaded members or cap screws 50, which are used to releasably secure the cavity ring 36 to the mold plate M and to maintain the position of the cavity ring during injection molding of the mold section 12. More particularly, with additional reference to FIGS. 3 and 4, the cavity ring 36 includes a plurality of bayonette lock sections 52 that enable the cap screws 50 to selectively secure the cavity ring 36 in abutting relation to an adjacent water jacket 54 and the mold plate M, while permitting removal of the cavity ring by merely loosening (and not necessarily removing) the cap screws.

Each bayonette lock section 52 includes a first aperture or notch 52a that is larger than a diameter of a head 50a of the cap screws 50 received in the bridge lock section. This permits removal of the cavity ring 36 over the cap screws (i.e., the cap screws need not be completely removed from the mold plate M to remove the cavity ring 36). The aperture 52a is open along a circumferential edge 56 of the cavity ring. Adjacent and connected to the aperture 52a is a second aperture or notch 52b. The second aperture 52b is sized to be larger than a shaft 50b of the cap screws 50, but smaller than the head 50a. Thus, when the cap screws 50 are received in the apertures 50b, the cavity ring 36 is prevented from being removed axially over the cap screws.

Each second aperture 52b is defined in a corresponding recessed portion 58 of the cavity ring 36. The recessed portion 58 is recessed relative to a surface 60 of the cavity ring 36 for purposes of allowing a fully inserted or threadedly engaged cap screw 50 to be mounted flush relative to or below surface 60. To install the cavity ring 36, the second apertures 52b are aligned with threaded bores 62 defined in the mold plate M. Then, if not already installed, the cap screws 50 are received through the aligned aperture 52b and bore 62 and threadedly engaged in the bore 62. If the cap screws 50 are already threadedly connected (i.e., installed) in the bore, then alignment of the second aperture 52b with the bore 62 causes the cap screws 50 to be received through the second apertures 52b. In either case, once the screws 50 are received in or aligned with the apertures 52b, the cap screws can be tightened to secure the cavity ring 36 in abutting relation with the water jacket 54 and the mold plate M. When fully secured, the heads 50a of the cap screws are in abutting relation to their corresponding recessed portions 58 and positioned below or flush with the surface 60.

To remove the cavity ring 36, the cap screws 50 are loosened (but not necessarily removed) to allow rotation of the cavity ring 36 relative to the water jacket 54 and/or the mold plate M. The cavity ring 36 is then rotated in a first direction (clockwise for the cavity ring shown in FIGS. 3 and 4) to align the screws 50 with the first apertures 52a. With the screws 50 aligned with the first apertures 52a, the cavity ring 36 can be simply removed (axially) over the heads 50a because the apertures 52a are sufficiently larger than the heads 50a to permit passing of the cavity ring thereby. Thus, removal does not require complete removal of the screws 50 which has the effect of increasing the speed at which the cavity ring can be removed.

More rapid removal of the cavity ring 36 enables more frequent and/or more rapid changes of the optical mold insert 38. More particularly, to remove and replace the optical mold insert 38 with another optical mold insert having a different optical molding surface, the cavity ring 36 is removed to provide access to the threaded retaining member 42. The faster the cavity ring 36 can be removed, the faster changes of the optical mold insert can be effected. Faster tool changes, which include changes of the optical mold insert, result in reduced downtime (i.e., non-molding or processing time) for the injection molding apparatus. Thus, the bayonette lock sections 52 allow the cavity ring 36 to be removed more rapidly which increases the overall speed at which the insert 38 can be removed and replaced with a substitute insert resulting in significantly less injection molding downtime.

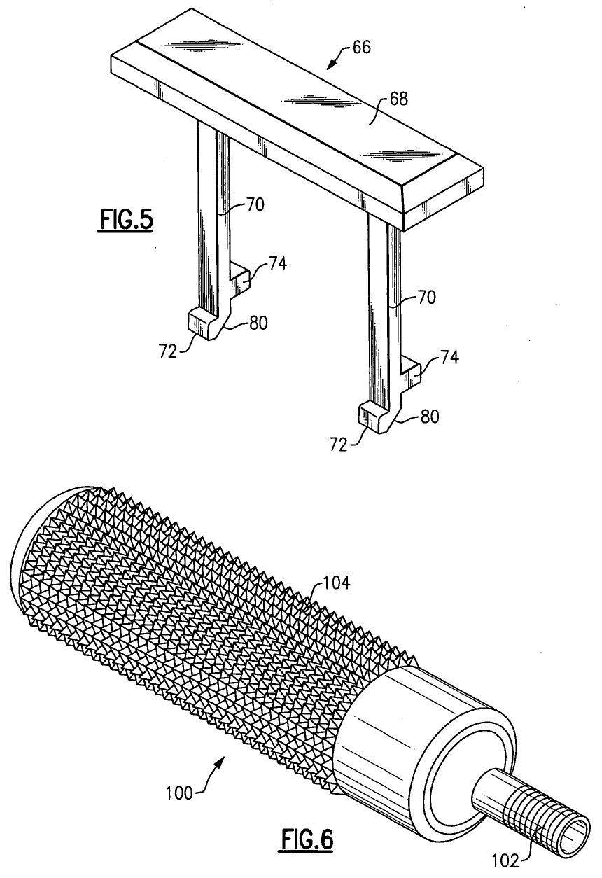

The cavity ring 36 preferably includes a rotating mechanism to assist in rotating the cavity ring upon loosening the cap screws 50. In the illustrated embodiment, the rotating mechansim for rotating the cavity ring includes tool receiving apertures 64 defined in the cavity ring surface 60. With additional reference to FIG. 5, the apertures 64 can be configured to operate with a corresponding rotational tool or device 66. The tool 66 includes a handle or gripping portion 68 with a pair of legs 70 extending therefrom. Each of the legs 70 includes a distal protrusion or barb 72 and a proximal protrusion or barb 74. The distal protrusions 72 are received under portions 76 defined in the apertures 64 of the cavity ring 36 and the proximal protrusions 74 are received against portions 78 defined in the apertures 64 opposite the portions 76. Chamfers 80 can be provided on the legs 70 and corresponding tapered surfaces 82 on the portions 78 to facilitate insertion and removal of the tool 66 into and from the apertures 64. The tool 66 is preferably formed of a material that is softer (i.e., has a lower hardness) than the cavity ring 36.

When the tool 66 is received in the apertures 64 wherein the tool lockingly engages the cavity ring 36, rotation of the cavity ring is effected by rotating the handle 68 of the tool 66. The exact configuration of the apertures 64 and the tool 66 need not be confined to those shown in the illustrated embodiment, nor need the means for rotating the cavity ring necessarily include the apertures 64 and/or the tool 66. As will be appreciated by those skilled in the art, the apertures 64 and tool 66 shown in the FIGURES are only illustrative of one example configuration which facilitates rotation of the cavity ring 36. Other rotating mechanisms and means can be provided for rotating the cavity ring and all such mechanisms and means should be considered within the scope of the invention. For example, tool flats could be provided circumferentially about the cavity ring for use with a wrench-type tool.

To reinstall or mount the cavity ring 36, the first apertures 52a are aligned with the threaded members 50 and the cavity ring is positioned over the threaded members and adjacent the water jacket 54 and the mold plate M. The cavity ring 36 is then rotated in a second direction (counterclockwise for the cavity ring shown in FIGS. 3 and 4) to align the screws 50 with the second apertures 52b. The screws 50 can then be tightened against the recessed portions 58 to secure the cavity ring 36 in position against the water jacket 54 and the mold plate M.

With reference to FIGS. 2-4, the optical tool insert 38 is received in a recess 84 defined in the surface 60 of the cavity ring 36 and shaft portion 38b of the insert 38 is received within another recess 86 defined in central protuberance 88 extending from a rear side 90 of the cavity ring 36. Surface 92, which defines the recess 84, also forms the non-optical outer surface of the cylindrical wall 22 and the segment wall 26 of the mold section 12 when formed in the mold cavity 30. As already indicated, the screw 42 removably secures the insert 38 to body 40. Head portion 38c of the insert 38 protrudes into the cavity recess 84 and includes the optical molding surface 38a that forms the optical surface 16 of the mold section 12.

More specifically, the screw 42 is received in a throughhole 84 defined centrally through the cavity ring protuberance 88 and is threadedly engaged to the insert 38 in a threaded bore 96 defined in the insert shaft portion 38b. Head 42a of the screw 42 is received in threaded counterbore 98. To change the insert 38, the cavity ring 36, with the body 40 and insert 38 attached, is removed from the mold plate M as described above. Then, with further reference to FIG. 6, body tool 100 having threads 102 is threadedly engaged in counterbore 98. While holding gripping portion 104, an axial pullout force is applied to the body 40 and insert 38 to remove them from the cavity ring 36. Once removed, the screw 42 is removed to disconnect the insert 38 from the body 40. A new or replacement insert, such as one having a varied optical molding surface for producing a lens of a different power, can then be attached to the body, which can be reinstalled into the cavity ring 36 prior to reattaching the cavity ring to the mold plate M. Alternatively, the other inserts can be maintained on corresponding bodies, like body 40, so that more rapid replacement of the inserts 38 into the cavity ring 36 can result (i.e., no threaded disconnection of the insert is necessary to change to another insert, only axial movement of the body relative to the cavity ring). As will be appreciated by those skilled in the art, the faster the cavity ring 36 can be removed from the mold plate M for providing access to the screw 42, the faster the insert 38 can be removed and replaced.

For cooling purposes, the water jacket 54 includes a cooling passage 110 into which a cooling medium or fluid, such as water, can be injected or directed from cooling lines on the injection molding apparatus for cooling the molded molding section 12 after injection molding. The non-optical tool assembly 34 can also include a cooling fluid passageway or cavity 112 fluidly connected to the cooling lines of the injection molding apparatus and, together with the cooling passage 110, provide balanced cooling (i.e., cooling to both sides) to molding sections, such as molding section 12, formed in the cavity 30.

A tapered interface 114 is formed between the cavity ring 36 and the waterjacket 54. More particularly, the tapered interface 114 is disposed between a tapered surface 116 of the cavity ring 36 and a corresponding or mating tapered surface 118 of the water jacket 54. The tapered surface 116 is defined circumferentially about the central protuberance 88. More specifically, the central protuberance 88 and its tapered surface 116 are received in a recess 120 defined in the water jacket 54 that forms the tapered surface 116. The tapered interface 114 is spaced from the cooling passage 110 which enables removal of the cavity ring 36 from the water jacket 54 without requiring an interruption in the cooling system or lines of the injection molding apparatus.

The tapered interface 114 also facilitates separation between the cavity ring 36 and the water jacket 54. More specifically, when the cavity ring 36 is pulled away from the water jacket 54, the tapered interface 114 offers relatively less resistance (such as, for example, compared to a non-tapered interface). In addition, the tapered interface 114 provides enhanced heat transfer between the water jacket 54 (and the cooling medium passing therethrough) and the cavity ring 36 because it enables a large amount of parting line contact between the water jacket 54 and the cavity ring 36.

To enhance heat transfer between components of the optical tooling assembly 32, one or more of the water jacket 54, cavity ring 36, insert 38 and body 40 can be formed of thermally conductive metals or alloys. In one embodiment, the water jacket 54 is formed of beryllium copper, and the insert 38, body 40 and cavity ring 36 are formed of brass, stainless steel, nickel, or some combination thereof. The molding surfaces 38a,92 can be formed according to methods generally known to those skilled in the art, such as for example lathe cutting or electrodischarge machining. The optical molding surface 38a can additionally be polished to achieve precision surface quality so that no, or only insignificant, surface imperfections are transferred to the mold section 12.

As illustrated, the cavity ring 36 mates with the non-optical tool assembly 34 along a parting line 122 to form the closed mold cavity 30. In one embodiment, the non-optical tool assembly 34 includes a core member 124, a non-optical insert or cap 126 and a stripper member 128 (which can be a stripper plate or sleeve, for example) annularly received about the core member. The non-optical insert 126 includes a first molding surface 130 that forms the surface opposite the optical surface 16 of the molding section 12 and a second molding surface 132 that forms an inner surface of the cylindrical wall 22 and an inner surface of the segment wall 26. The non-optical insert 126 is removably secured to the core member 124 which can be conventionally secured to the injection molding apparatus. Of course, as would be apparent to one skilled in the art, the exact design or configuration to accommodate the molding assembly 34, as well as the molding assembly 32, will depend on the injection molding apparatus.

The non-optical insert molding surface 130, used to form the non-optical surface opposite the optical surface 16 of mold section 12, does not require an optical quality finish as it does not contact the polymerizable lens mixture in the lens casting process. Thus, the surface 130 does not require the same degree of polishing as the optical molding surface 38a which is used to form the optical surface 16. However, some polishing or grinding of surface 118 may still be required. In one embodiment, the core member 124 is formed of beryllium copper, which has enhanced heat transfer characteristics, while the insert 126 is formed of a material that is more desirable to machine than BeCu from an environmental/biohazards standpoint, such as cooper, nickel or tin alloys. The molding surfaces 130,132 can be formed according to generally known methods, such as lathe cutting or electrodischarge machining.

A runner or sprue 134 is disposed between the tooling assemblies 32,34 and fluidly connected to the cavity 30 for allowing molten resin to be injected into the cavity when injection molding the mold section 12. In the illustrated embodiment, the runner 134 connects to the cavity 30 along a portion thereof that forms the cylindrical wall 22 and thereby does not interfere with the molding of the optical surface 16. The runner 134 is formed by a first channel 136 defined in the cavity ring 36 and a second channel 138 defined in the stripper member 128, which is aligned with the first channel 124. The cavity ring 36 can additionally include a slotted dowel hole 140 that receives a dowel of the mold plate M for precisely aligning the cavity ring 36.

The exemplary embodiment has been described with reference to one or more embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. An optical tool assembly for use in an injection molding apparatus opposite a non-optical tool assembly to form an ophthalmic mold section, comprising:
a water jacket mounted to an associated mold plate of the injection molding apparatus;
a cavity ring secured by a rotatable lock to the associated mold plate in abutting relation to said water jacket along a tapered interface;
an optical insert removably secured to said cavity ring and having an optical molding surface thereon for forming an optical surface of the ophthalmic mold section; and
wherein said rotatable lock enables removal of said cavity ring from said associated mold plate when said cavity ring is rotated to an unlocked position.

2. The optical tool assembly of claim 1 wherein said rotatable lock includes fasteners securing said cavity ring to said associated mold plate wherein said fasteners each have a shaft received through first apertures defined in said cavity ring when said fasteners are rotatably aligned with said first apertures and received through second apertures defined in said cavity ring and connected to said first apertures when said fasteners are rotatably aligned with said second apertures, heads on said fasteners smaller than said first apertures and larger than said second apertures.

3. The optical tool assembly of claim 1 wherein said rotatable lock enables axial removal of said cavity ring from said associated mold plate only when said cavity ring is rotataed to said unlocked position.

4. An apparatus for injection molding an ophthalmic lens mold having an optical surface and a non-optical surface opposite the optical surface, comprising:
a non-optical tool assembly for forming the non-optical surface of the ophthalmic lens mold;
an optical tool assembly in opposed relation to said non-optical tool assembly that together therewith forms a mold cavity for forming the ophthalmic lens mold, said optical tool assembly includes:
a cavity ring removably secured to a mold plate of an injection molding apparatus, axial removal of said cavity ring enabled when said cavity ring is rotated to an unlocked position and prevented when said cavity ring is rotated to a locked position, and
an optical tool insert having an optical molding surface thereon for forming the optical surface of the ophthalmic lens mold, the optical tool insert removably secured to said cavity ring.

5. The apparatus of claim 4 wherein at least one threaded member having a head is used to removably secure said cavity ring to the mold plate and maintain the position of said cavity ring relative to the mold plate during injection molding of the ophthalmic lens.

6. The apparatus of claim 5 wherein the cavity ring includes a bayonette lock section for each of said at least one threaded member that removably secures the cavity ring to the mold plate, said bayonette lock section includes:
a first aperture that is larger than said threaded member head permitting removal of said cavity ring over said at least one threaded member when said first aperture is aligned with said at one threaded member; and
a second aperture connected to said first aperture, said second aperture larger than a shaft of said at least one threaded member and smaller than said threaded member head thereby preventing removal of said cavity ring over said at least one threaded member when said second aperture is aligned with said at least one threaded member and allowing said threaded member head to be tightened against said cavity ring.

7. The apparatus of claim 6 wherein each second aperture is defined in a recessed portion of said cavity ring which is recessed relative to a front surface of said cavity ring.

8. The apparatus of claim 6 wherein said cavity ring is rotatable in a first direction to align said at least one threaded member with said first aperture and rotatable in the opposite direction to align said at least one threaded member with said second aperture.

9. The apparatus of claim 8 wherein said cavity ring includes a rotating mechansim for rotating said cavity ring when said at least one threaded member is loosened.

10. The apparatus of claim 9 wherein the rotating mechanism for rotating said cavity ring includes:
tool receiving apertures defined in said cavity ring; and
a tool selectively insertable in said tool receiving apertures wherein said tool may be manipulated to rotate said cavity ring.

11. The apparatus of claim 4 wherein said optical tool assembly includes a threaded member that removably secures the optical tool insert to the cavity ring, said threaded member is received through an aperture in said cavity ring and threadedly engages said optical tool insert.

12. The apparatus of claim 11 wherein said optical tool insert is received within a recess defined in said cavity ring, a surface defining said recess forms an optical tool assembly molding surface for forming outer surfaces of said ophthalmic lens mold, and a head portion of said optical tool insert protrudes into said recess and includes said optical molding surface thereon.

13. The apparatus of claim 4 wherein said optical tool assembly includes a water jacket in abutting relation to said cavity ring, said water jacket having a cooling passage for receiving a cooling medium therein for cooling said mold cavity.

14. The apparatus of claim 13 wherein said cavity ring and optical tool insert are together removable from said water jacket for changing of said optical tool insert on said cavity ring without disruption of said cooling medium contained in said water jacket.

15. The apparatus of claim 13 wherein said optical tool assembly includes a tapered interface between said cavity ring and said water jacket.

16. The apparatus of claim 15 wherein said cavity ring has a central protuberance having a tapered surface that is received within a water jacket recess having a mating tapered surface that abuts said cavity ring tapered surface to create said tapered interface.

17. The apparatus of claim 4 wherein said non-optical tool assembly includes:
a core member having a cooling cavity with a cooling medium therein for cooling the ophthalmic lens mold after injection molding, said core member removably secured to a second mold plate of said injection molding apparatus;
a non-optical insert removably secured to said core member at a location spaced from said cooling cavity, said non-optical insert having a first molding surface for forming a surface of the ophthalmic lens mold opposite the optical surface; and
a stripper member annularly disposed on said core member and positioned to forcibly remove the ophthalmic lens mold from said non-optical insert after injection molding thereof upon advancement of said stripper member.

18. The apparatus of claim 17 wherein said cavity ring and said stripper member define a runner fluidly connected to said mold cavity for allowing molten resin to be injected into said mold cavity when injection molding the ophthalmic lens mold.

19. The apparatus of claim 4 wherein said mold cavity is shaped to form the ophthalmic lens mold as one of a posterior lens mold or an anterior lens mold.

20. An injection molding apparatus for forming a mold section which is subsequently used for forming an ophthalmic lens, comprising:
a cavity ring having a tapered central protuberance and mounted to an associated first mold plate;
an optical tool insert removably mounted to said cavity ring, said optical tool insert having a molding surface with an optical quality finish;
a water jacket having a tapered recess and mounted to said associated first mold plate, said tapered central protuberance of said cavity ring received in said tapered recess and forming a tapered interface therewith;
a core member mounted to an associated second mold plate opposite the associated first mold plate; and
a non-optical tool insert removably mounted to said core member, said non-optical insert having a first molding surface for forming a surface of the mold section opposite the optical surface.

21. The injection molding apparatus of claim 20 wherein said cavity ring, said optical insert and said non-optical insert together form a mold cavity shaped to mold the mold section.

22. The injection molding apparatus of claim 19 further including at least one threaded member having a head removably securing said cavity ring to the mold plate, said at least one threaded member received through a first aperture defined in said cavity ring, said first aperture having a diameter that is larger than said head permitting removal of said cavity ring over said threaded member when said first aperture is aligned with said at least one threaded member.

23. The injection molding apparatus of claim 22 wherein a second aperture is defined in said cavity ring adjacent and connected to said first aperture, said second aperture has a diameter that is smaller than said head thereby preventing removal of said cavity ring over said at least one threaded member when said second aperture is aligned with said at least one threaded member and allowing said at least one threaded member to be used to tighten said cavity ring against at least one of said water jacket and said associated first mold plate, said first and second apertures positioned on said cavity ring so that rotation of said cavity ring selectively aligns said at least one threaded member with said first and second apertures.

24. A method for forming an ophthalmic lens, comprising the steps of:
providing an injection molding apparatus having an optical tool assembly having an optical mold surface for forming an optical surface of an anterior mold section and a non-optical tool assembly in opposed relation to said optical tool assembly, said optical tool assembly and said non-optical tool assembly together forming a mold cavity, said optical tool assembly including a water jacket mounted to an associated mold plate of the injection molding apparatus, a cavity ring mounted by at least one fastener to the associated mold plate in abutting relation to said water jacket along a tapered interface and an optical insert removably secured to said cavity ring and having said optical mold surface thereon;
injection molding said anterior mold section in said mold cavity;
removing said molded anterior mold section from said mold cavity;
matching said anterior mold section with a posterior mold section; and
cast molding an ophthalmic lens between said anterior mold section and said posterior mold section.

25. An ophthalmic lens formed according to the method of claim 24.
